(19) United States
(12) Patent Application Publication
(10) Pub. No.: US 2022/0012586 A1
(43) Pub. Date: Jan. 13, 2022

(54) INPUT MAPPING TO REDUCE NON-IDEAL EFFECT OF COMPUTE-IN-MEMORY

(71) Applicant: MACRONIX INTERNATIONAL CO., LTD., HSINCHU (TW)

(72) Inventors: Yu-Hsuan LIN, TAICHUNG (TW); Po-Kai HSU, TAINAN (TW); Dai-Ying LEE, Hsinchu (TW)

(73) Assignee: MACRONIX INTERNATIONAL CO., LTD., HSINCHU (TW)

(21) Appl. No.: 17/079,341

(22) Filed: Oct. 23, 2020

Related U.S. Application Data
(60) Provisional application No. 63/050,874, filed on Jul. 13, 2020.

(51) Int. Cl. G06N 3/08; G06N 5/04

(52) U.S. Cl. CPC G06N 3/08; G06N 5/04

(57) ABSTRACT

An inference engine for a neural network uses a compute-in-memory array storing a kernel coefficients. A clamped input matrix is provided to the compute-in-memory array to produce an output vector representing a function of the clamped input vector and the kernel. A circuit is included receiving an input vector, where elements of the input vector have values in a first range of values. The circuit clamps the values of the elements of the input vector a limit of a second range of values to provide the clamped input vector. The second range of values is more narrow than the first range of values, and set according to the characteristics of the compute-in-memory array. The first range of values can be used in training using digital computation resources, and the second range of values can be used in inference using the compute-in-memory array.

### PRIORITY APPLICATION

This application claims the benefit of U.S. Provisional Patent Application No. 63/050,874 filed 13 Jul. 2020; which application is incorporated herein by reference.

### BACKGROUND

### Field

The present invention relates to improvements in technology implementing artificial neural networks, and particularly such networks comprising memory devices characterized by non-ideal memory device behavior.

### Description of Related Art

Artificial neural network ANN technology has become an effective and important computational tool, especially for the realization of artificial intelligence. Deep neural networks are a type of artificial neural networks that use multiple nonlinear and complex transforming layers to successively model high-level features. For the purposes of training, deep neural networks provide feedback via backpropagation which carries the difference between observed and predicted output to adjust model parameters. Deep neural networks have evolved with the availability of large training datasets, the power of parallel and distributed computing, and sophisticated training algorithms. ANNs of all kinds, including deep neural networks, have facilitated major advances in numerous domains such as computer vision, speech recognition, and natural language processing.

Convolutional neural networks (CNNs) and recurrent neural networks (RNNs) can be used in, or as components of, deep neural networks. Convolutional neural networks have succeeded particularly in image recognition with an architecture that comprises convolution layers, nonlinear layers, and pooling layers. Recurrent neural networks are designed to utilize sequential information of input data with cyclic connections among building blocks like perceptrons, long short-term memory units, and gated recurrent units. In addition, many other emergent deep neural networks have been proposed for various contexts, such as deep spatio-temporal neural networks, multi-dimensional recurrent neural networks, and convolutional auto-encoders.

In some applications, the training of an ANN system is done using high-speed computing systems using distributed or parallel processors, and the resulting set of parameters is transferred to a memory in a computational unit, referred to herein as an inference engine, implementing a trained instance of the ANN to be used for inference-only operations. However, the behavior of the memory cells in the inference-only machine can be non-ideal, particularly in some types of nonvolatile memories, because of programming error, memory level fluctuations, noise and other factors. This non-ideal behavior of the memory cells storing the parameters can cause computing errors in the inference engine applying the parameters. These computing errors, in turn, result in loss of accuracy in the ANN system.

One arithmetical function applied in ANN technology is a “sum-of-products” operation, also known as a “multiply-and-accumulate” operation. The function can be expressed in simple form as follows:

$$f ( {x}_{i} ) = {\sum }_{i = 1}^{M} {W}_{i} {x}_{i}$$

In this expression, each product term is a product of a variable input Xᵢ and a weight Wᵢ. The weight Wᵢ is a parameter that can vary among the terms, corresponding, for example, to parameters of the variable inputs Xᵢ. ANN technologies can include other types of parameters as well, such as constants added to the terms for bias or other effects.

A variety of techniques is being developed to accelerate the multiply-and-accumulate operation. One technique is known as “compute-in-memory CIM”, involving use of nonvolatile memory, such as resistive memory, floating gate memory, phase change memory and so on, arranged to store data representing the parameters of the computation, and provide outputs representing sum-of-products computation results. For example, a cross-point ReRAM array can be configured in a CIM architecture, converting an input voltage into current as a function of the electrical conductance of the memory cells in the array, and providing a sum-of-products operation using multiple inputs and one cross-point string. See for example, Lin et al., “Performance Impacts of Analog ReRAM Non-ideality on Neuromorphic Computing”, IEEE Transactions on Electron Devices, Vol. 66, No. 3, March 2019, pp. 1289-1295, which is incorporated by reference as if fully set forth herein.

However, the nonvolatile memory used in CIM systems can be non-ideal, because the memory cells can have non-constant conductances, which represent the coefficients or weights in the operation. ReRAM, for example, can have memory cells with conductances that vary as a function of both the read voltage and the programmed conductance (referred to as a target conductance herein).

It is desirable therefore to provide technology for improving ANN systems that utilize non-ideal memory to store parameters, including to store parameters generated during machine learning procedures for a CIM system.

### SUMMARY

An inference engine for a neural network is described, which comprises a compute-in-memory array storing kernel coefficients. The inputs of the compute-in-memory array are configured to receive a clamped input vector which can be part of a clamped input matrix, and to produce an output vector representing a function of the clamped input vector and the kernel. A circuit is included that is operatively coupled to a source of an input vector, where elements of the input vector have values in a first range of values. The circuit is configured to clamp the values of the elements of the input vector a limit of a second range of values to provide the clamped input vector. The second range of values is more narrow than the first range of values, and set according to the characteristics of the compute-in-memory array. The first range of values can be used in training using digital computation resources, and the second range of values can be used in inference using the compute-in-memory array.

The compute-in-memory array comprises memory cells storing elements of the kernel. The memory cells have conductances with deviations in amounts that can be a function of the input voltages at the memory cells, can be a function of the conductances of the memory cell set at target conductances during a programming operation, and can be a function of both the input voltages and the target conductances.

The inference engine can include digital-to-analog converters DAC to transduce the clamped input vector to analog voltages representing the elements of the clamped input vector. The analog outputs of the digital-to-analog converters are applied to the inputs of the compute-in-memory array. The compute-in-memory array can be configured to operate within a voltage range for the analog voltages. The digital-to-analog converters transduce the elements of the clamped input vector to the full voltage range, or most of the voltage range, of the compute-in-memory array during the inference operation. During a training operation, the machine can utilize the input vector in digital format, across its full range of values.

The neural network can comprise a plurality of layers, including a first layer, one or more intermediate layers and a final layer. The compute-in-memory array can be a component of an intermediate layer in the one or more intermediate layers. The source of the input vector can include a preceding layer or multiple preceding layers, including a first layer, in the plurality of layers.

In some embodiments, the preceding layer, acting as a source of the input vector, can apply an activation function to produce the input vector, both in the inference and in the training operations. The circuit deployed in the inference engine can clamp the values of the elements at the output of the activation function. The circuit can combine the clamping function with the activation function.

The logic that clamps the values of the elements of the input vector can be coupled to a register that stores programmable limits of the range of the clamping circuit. These programmable limits can be set according to the characteristics of the input vector or matrix, and according to the characteristics of the memory technology utilized in the compute-in-memory array.

In embodiments of the present technology, the compute-in-memory array and, the circuit that clamps the input vector the register storing the limits of the clamping range, and the digital-to-analog converters can be components of a single integrated circuit.

A method for operating an inference engine is described, that includes storing a kernel of coefficients in a compute-in-memory array, and applying a clamped input vector to the compute-in-memory array to produce an output vector representing a function of the clamped input vector and the kernel. The method can include modifying an input vector, where elements of the input vector have values in a first range of values, by clamping the values of the elements of the input vector at a limit of a second range of values to provide the clamped input vector, where the second range of values is more narrow than the first range of values.

The method can include training the neural network using the first range of values of the input vector, without clamping, in a digital sum-of-products engine.

A memory device is described including a first computing unit receiving an image signal to generate a first output signal; a mapping range circuit coupled to the first computing unit and converting the first output signal to a limited range signal; and a second computing unit coupled to the mapping circuit and receiving the limited range signal to generate a second output signal; wherein the limited range signal is confined with an upper bound and a lower bound.

Other aspects and advantages of the present invention can be seen on review of the drawings, the detailed description and the claims, which follow.

### BRIEF DESCRIPTION OF THE DRAWINGS

FIG. 1 is a simplified representation of a compute-in-memory circuit as described herein.

FIG. 2 is a graph of read voltage versus conductance for memory cells of a compute-in-memory circuit for a range of program conductance values.

FIG. 3 is a chart showing a distribution of input values, provided by the output of a preceding layer in a neural network, for example, such as might be generated by processing input images, combined with a ReLU activation function.

FIG. 4 is a chart showing the distribution of multiply-and-accumulate values produced by simulation of a compute-in-memory array with ideal conductances.

FIG. 5 is a chart showing the distribution of multiply-and-accumulate values produced by simulation of a compute-in-memory array with non-ideal conductances.

FIG. 6A illustrates a limited input range which can be defined for use in a clamping circuit as described herein, for an input distribution like that of FIG. 3.

FIG. 6B illustrates a mapping of the clamped input range to the analog voltage range used as input in a compute-in-memory array.

FIG. 7 is a chart showing the distribution of multiply-and-accumulate values produced by simulation of a computer memory array having a clamped input vector as described herein.

FIG. 8 is a simplified graph illustrating a limited range of input values for one type of distribution of input values.

FIG. 9 is a simplified graph illustrating a limited range of input values for another type of distribution of input values.

FIG. 10 is a block diagram of an implementation of a neural network including a layer having a clamping circuit and compute-in-memory array as described herein.

FIG. 11 is a block diagram of an implementation of a neural network including a layer in which the clamping circuit is combined with an activation function.

### DETAILED DESCRIPTION

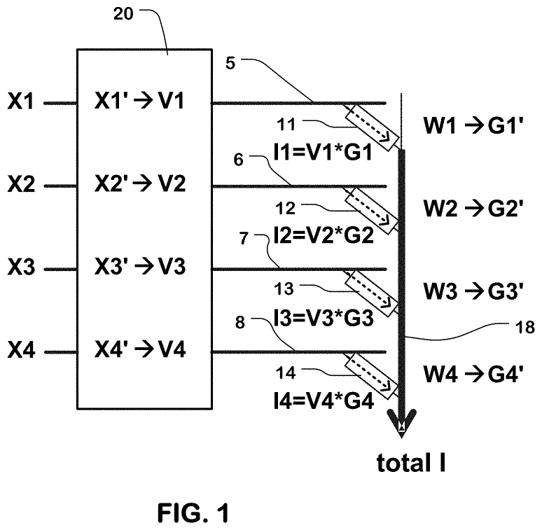

A detailed description of embodiments of the present invention is provided with reference to the FIGS. 1-11.

FIG. 1 is a schematic illustration of a portion of a compute-in-memory array. The array stores a part of a kernel of coefficients, including weights W1 to W4 in this example, utilized in a sum-of-products operation. This portion of the array includes nonvolatile memory cells 11, 12, 13, 14, programmed with target conductances G1′, G2′, G3′, G4′ to represent the weights. The array has inputs 5, 6, 7, 8 (such as word lines) which apply analog voltages V1, V2, V3, V4 to corresponding nonvolatile memory cells 11, 12, 13, 14. The analog voltages V1, V2, V3, V4 represent respective elements of an input vector X1, X2, X3, X4. An input circuit 20 is operatively coupled to a source of the input vector X1, X2, X3, X4, where elements of the input vector have values in a first range of values. The input vector X1, X2, X3, X4 can be represented using floating point encoding, such as 16-bit floating point or 32-bit floating point representations including, for examples, encoding formats described in IEEE Standard for Floating-Point Arithmetic (IEEE 754). Also, the input vector can be encoded in binary digital form in some embodiments.

The input circuit 20 is configured to clamp the values of the elements of the input vector (or matrix) at a limit of a second range of values to provide a clamped input vector (X1′, X2′, X3′, X4′) represented by the analog voltages V1 to V4, the second range of values being more narrow than the first range of values. The full first range of values can be used in the training algorithms using digital computation resources. So, the clamped range of input values is more narrow that the range used during training.

The clamping in the input circuit can be implemented using a digital circuit to compute the clamped values, with a digital-to-analog converter to provide the output voltages V1 to V4. Also, the clamping in the input circuit can be computed in analog circuits, such as by clamping the outputs of digital-to-analog converters for each element of the input vector to provide the output voltages V1 to V4.

The nonvolatile memory cells 11, 12, 13, 14 have conductances G1, G2, G3, G4, which can fluctuate or vary as a function of the analog input voltage, and as a function of the target conductances of the cell, as a function of both the input voltage and the target conductances, and as functions of other factors, depending on the particular implementation and type of nonvolatile cell being utilized.

Currents I1 to I4 are generated in each of the memory cells, and combined on an output conductor 18, such as a bit line. The currents in each of the cells is combined to produce a total current “total I”, representing a sum-of-products as follows:

V1*G1+V2*G2+V3*G3+V4*G4

The present technology can be applied using many types of target memory technologies in the compute-in-memory CIM inference engines, including nonvolatile memory technologies. Examples of nonvolatile memory cell technologies operable as programmable resistance memory include floating gate devices, charge trapping devices (e.g., SONOS), phase change memory devices (PCM), transition metal oxide resistance change devices (TMO ReRAM), conduction bridge resistance change devices, ferroelectric devices (FeRAM), ferroelectric tunneling junction devices (FJT), magnetoresistive devices (MRAM), and so on.

Embodiments of the nonvolatile memory device can include memory arrays operated in an analog mode. An analog mode memory can be programmed to desired values in many levels, such as eight or more levels, that can be converted to digital outputs of multiple bits, such as three or more bits. Due to device physical characteristics there can be accuracy issues (from programming error, device noise . . . etc.) resulting in memory level spread out, forming a distribution even for cells intended to have the same “value”. To program an analog memory cell, the data can be stored by simply applying a single program pulse. Also, a programming operation can use multiple programming pulses, or a program-and-verify scheme to increase the programming accuracy by confining the value distribution (value error) into an acceptable range.

For example, an analog mode memory can use as high as 64-levels or 100-levels, which is effectively analog because such many-level memory operates with distributions of levels overlapping across neighboring memory states (for example a cell in an array may not be confidently read as level #56 or level #57 due to the level shift from error, noise, etc.).

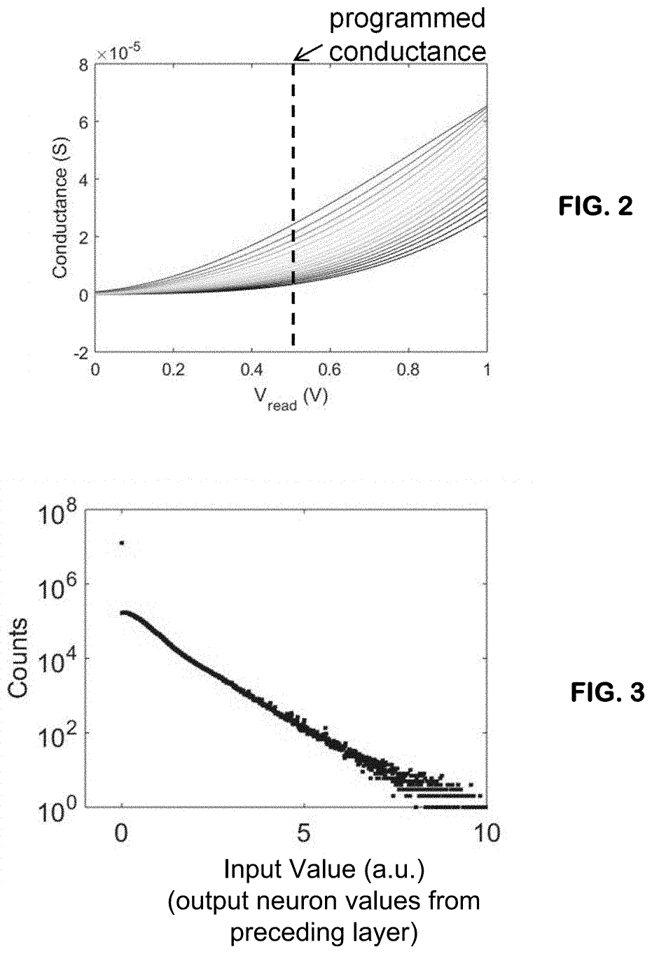

FIG. 2 is a chart of conductance versus read voltage as the read voltage is swept from 0 to 1 V in a plurality of cells in an ReRAM array based on transition metal oxide memory material, illustrating the non-constant conductances. As can be seen, the actual conductance on the vertical axis for a given read voltage varies across the sampled cells, by amounts that depend on the read voltage level, and on the target conductance or programmed conductance of the cell. Also, this variation is greater at higher read voltages than at lower read voltages for the ReRAM embodiment.

FIG. 3 is a statistical distribution plot of data values in arbitrary units generated over 10,000 input images by a convolutional layer, and processed by a rectified linear unit ReLU activation function that is also used during training, so that all values are greater than or equal to zero. This distribution represents an example of data to be applied to a second layer of the neural network, which can be implemented using CIM. In this example, the input values in the lower range of the distribution are much more numerous that values in the upper range.

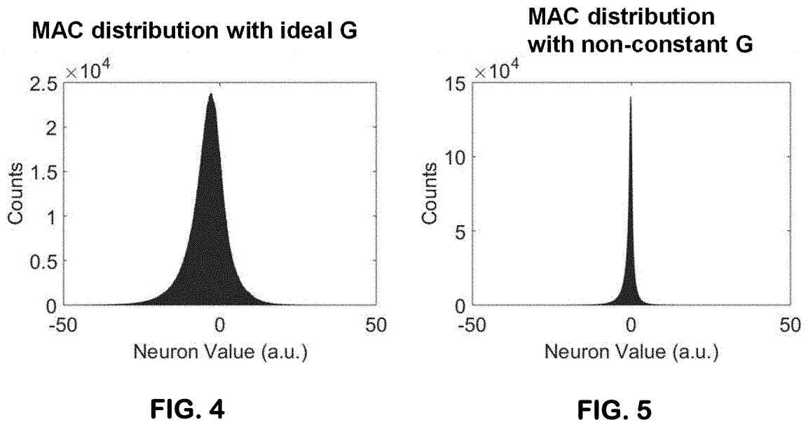

FIG. 4 is a simulated statistical distribution plot of outputs of multiply and accumulate MAC operations using ideal conductances for the nonvolatile memory of a CIM circuit, for a convolutional layer receiving data like that of FIG. 3 as input. This is to be compared with FIG. 5, which is a simulated statistical distribution plot of outputs of MAC operations using non-ideal conductances for the nonvolatile memory of a CIM circuit, for a convolutional layer receiving data like that of FIG. 3 as input. The distribution in FIG. 5 of results from non-ideal conductances is substantially different than that in FIG. 4 showing results from ideal conductances.

In the example represented by FIGS. 3-5, using a neural network including 6 convolutional layers, with 3 fully connected layers, the inference accuracy degrades from an ideal value of about 90.4% using ideal conductances to as low as 21.5% using non-ideal conductances.

In order to compensate for non-ideal conductances, an input mapping technology, as discussed with reference to FIG. 1, is provided that can obtain a more uniform and symmetrical input distribution. According to embodiments of the present technology, this input mapping can enable generation of results from CIM computations using nonvolatile memory closer to the results achievable using ideal conductances. This can result in better inference accuracy.

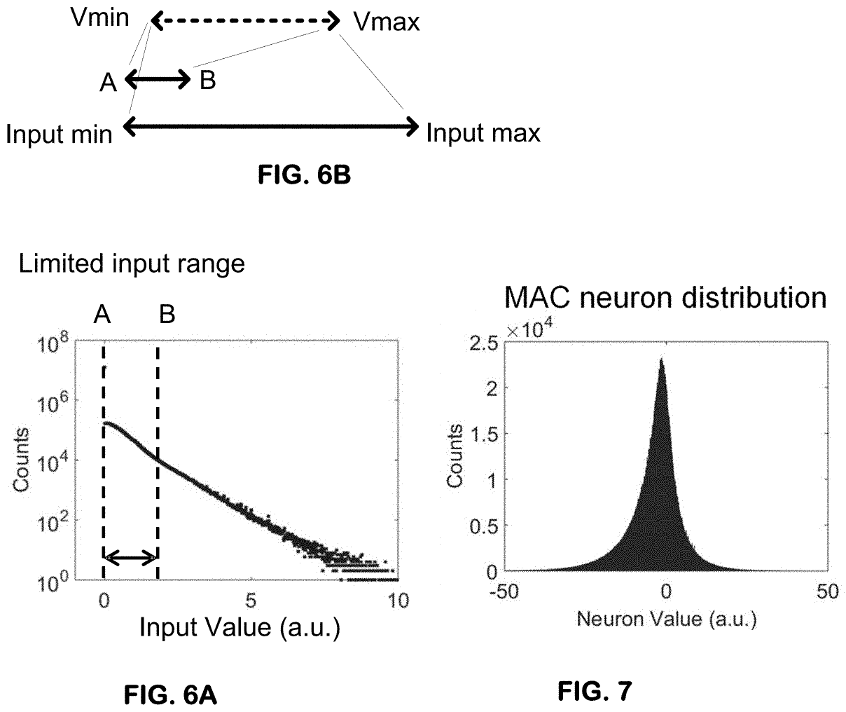

FIG. 6A illustrates an example of an input mapping that can be applied to the system of FIGS. 3-5, in which the input values across a first range of values (0 to 10 a.u. in this example) are clamped within a second range (A to B), wherein A is zero and B is about 2 a.u., in this example. The input clamping can be applied in the first layer of a neural network, in one or more intermediate layers, and in an output layer. FIG. 7 illustrates simulation of results in which the clamping is applied in the second layer of the neural network including 6 convolutional layers, with 3 fully connected layers considered with reference to FIGS. 3-5. As illustrated, by clamping the input values at the limits of the range A to B, the results of the CIM operations can produce results with a distribution like that of FIG. 7, which is much closer to the distribution of FIG. 4 for the ideal conductances case.

The clamped input values, represented for example using a floating point encoding format, can be converted to analog values across the full range of available input voltages for the CIM nonvolatile array, such as between 0 and 1 volts.

FIG. 6B illustrates conversion of an input range from an input min to an input max to a full range of analog voltages, Vmin to Vmax, as compared to the conversion of the clamped range from A to B, to the full range in analog voltage Vmin to Vmax. The range Vmin to Vmax is preferably designed so that it falls within an operating range for the CIM array. The range Vmin to Vmax can include voltages that span between threshold voltages of ideal erased states and programmed states in the CIM array, so that the cells are operated in an analog mode.

As a result, in the example presented here, the inference accuracy improves from 21.5% to 88.7%, close to the accuracy for the ideal case of 90.4%.

If the activation function also used during training is not ReLU (or similar), as in the example of FIG. 6A, the layer providing input produces elements of the output matrix having both positive and negative values. In this case, the input voltage mapping can include shifting and scaling the input value distribution to the defined input voltage distribution. For example, the most negative input value and the most positive value can be the low and the high boundary of the input voltage range, respectively.

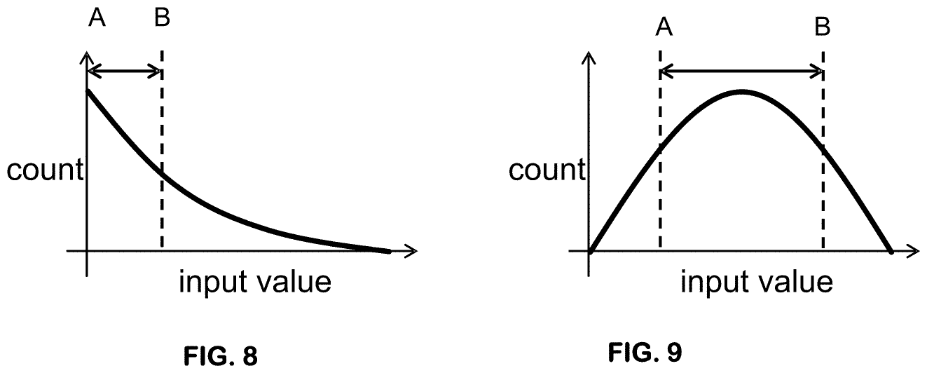

FIGS. 8 and 9 illustrate example clamping functions for input data values having different distributions of values. In FIG. 8, the input values fall in a range that has a peak in count at a lower edge and falls in count as the values increase, like that shown in FIGS. 3 and 6. In the example of FIG. 8, the input values can be clamped between the lower edge A and the value B. In FIG. 9, the input values have a peak count between the limits A and B of the range, and fall off in a gaussian like curve as the values extend away from the peak count value. By clamping the input values between the limits A and B, the inference accuracy can be improved as discussed above in systems using CIM circuits.

A circuit (e.g. circuit 20 of FIG. 1) can be provided that receives the input values from a previous layer, and clamps the values at the limits A and B of the range. For example, a clamp circuit can implement the logical function:

$$range boundary values ( low ) a and ( high ) b$$

$$signal x \to \{ \begin{matrix}y = a , & if x < a \\ y = b , & if x > b \to signal y \\ y = x , & if a \leq x \leq b\end{matrix}$$

An output of the clamping circuit is a set of input values (a vector or matrix) for the next layer that falls in the range of A to B, rather than the larger range from the previous layer. During training, the larger range of the input values can be used to determine the coefficients to be stored as target values, such as target conductances in nonvolatile memory cells, within the precision of the programming procedures and memory technologies used. The clamped ranges of the input values are implemented at the inference engine.

For the purposes of the present description, the phrase “to clamp the values at a limit of a second range” means for an upper limit of the range that elements having values greater than the upper limit are set to the upper limit, or to about the upper limit, and for a lower limit of the range that elements having values lesser than the lower limit are set to the lower limit or to about the lower limit. Clamped values at about the lower limit or at about the upper limit are close enough to the respective limits to be effective in improving inference accuracy of the neural network.

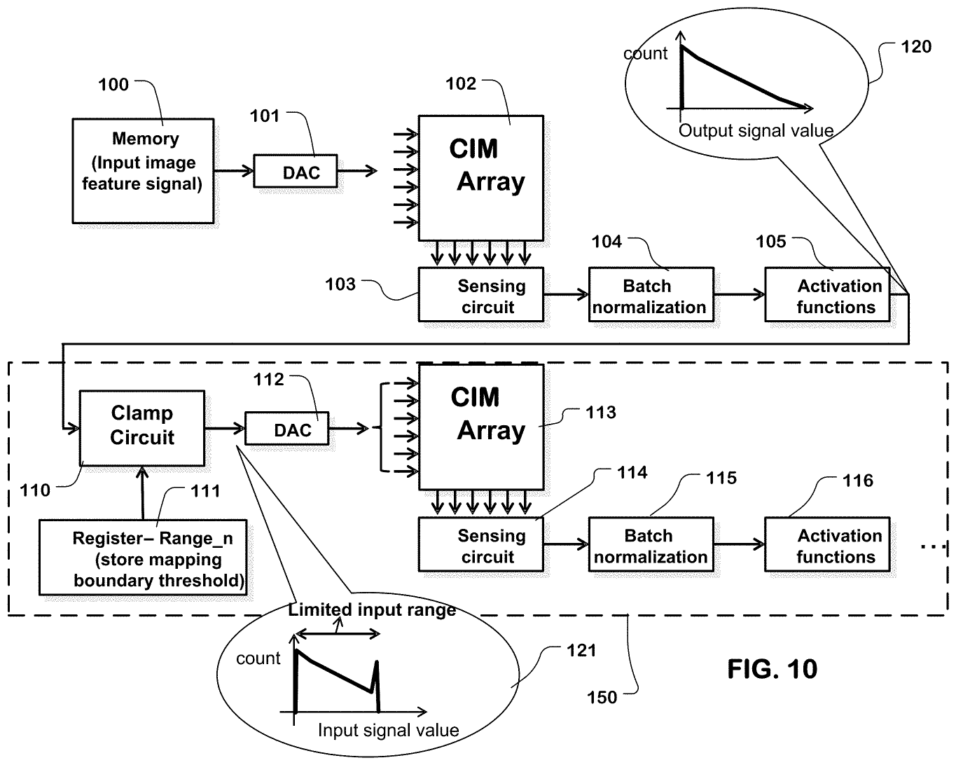

FIG. 10 is a diagram of a neural network including circuits as described herein. In this example neural network, the input to the neural network is an image feature signal, which can comprise an array of pixel values represented by elements of 2D or 3D matrices stored in memory 100. A digital-to-analog converter 101 converts the elements of the input from memory 100 to analog voltages applied to a CIM nonvolatile memory array 102, which stores a kernel of coefficients (or weights) generated by a training procedure for use in the corresponding layer of the neural network. The sum-of-products outputs of the array 102 are applied to a sensing circuit 103, which provides digital outputs to a batch normalization circuit 104 followed by activation functions 105 executed by digital domain circuits. The output of the activation functions 105 can comprise a matrix having a distribution of element values in a digital format, such as a floating point format. The distribution can be like that shown at 120, similar to that described above with reference to FIG. 3, for one example.

In circuits as described herein, the outputs of the activation functions 105 of the input layer of the neural network (which can be a first layer or an intermediate or hidden layer) are applied as input to a next layer in the neural network, represented generally by the components of block 150. In one implementation, the components of block 150, including at least the clamping logic, the digital-to-analog converter, and the CIM array, are implemented on a single integrated circuit or multichip module, which comprise more than one chip packaged together.

The input values (output from the activation functions 105) are input to a clamp circuit 110 executing a clamp function in response to a limit value stored in a register 111. The clamp function is not used during training in some embodiments. Register 111 can store the limits A, B of the digital range for the clamp circuit, where the limits are set according to the CIM architecture and the neural network functions. The output of the clamp circuit can comprise a matrix having elements with values that fall in a distribution like that shown at 121, clamped on the lower edge of the range at a value of 0 (A=0), and clamped at a higher edge of the range of value B. This causes the distribution for a clamped matrix to include a peak count of element values at the edges of the range near the value B.

The elements of the clamped matrix are applied as inputs to a digital-to-analog converter DAC 112, which converts the clamped range of digital values to a range of analog input voltages for the array 113, which can be a full specified range for operation of the array 113. The digital-to-analog converters can be part of word line drivers in the CIM array, for example. The voltages are applied to the array 113, which stores a kernel of coefficients (or weights) generated by a training procedure for use in the corresponding layer of the neural network, and which generates sum-of-products outputs, applied to sensing circuit 114. The output of the sensing circuit can be applied to a batch normalization circuit 115, the outputs of which are applied to activation functions 116. This second layer of the neural network can provide its output values to further layers in a deep neural network as discussed above. The circuits in block 150, which can be implemented on a single integrated circuit or multichip module, can be reused for subsequent layers in a cyclic manner. Alternatively, multiple instances of the circuit shown in FIG. 10 can be implemented on a single integrated circuit or multichip module.

The logical functions of the circuit (block 150) can be implemented by dedicated or application specific logic circuits, programmable gate array circuits, general purpose processors executing a computer program, and in combinations of such circuits. The array 113 can be implemented using programmable resistance memory cells, such as described above.

In some embodiments, the clamp circuit can be implemented in an analog format. For example, the DAC 112 can generate a wide range of analog values, provided to an analog clamping circuit having clamp limits set using one time only programming, or by the value stored in register 111.

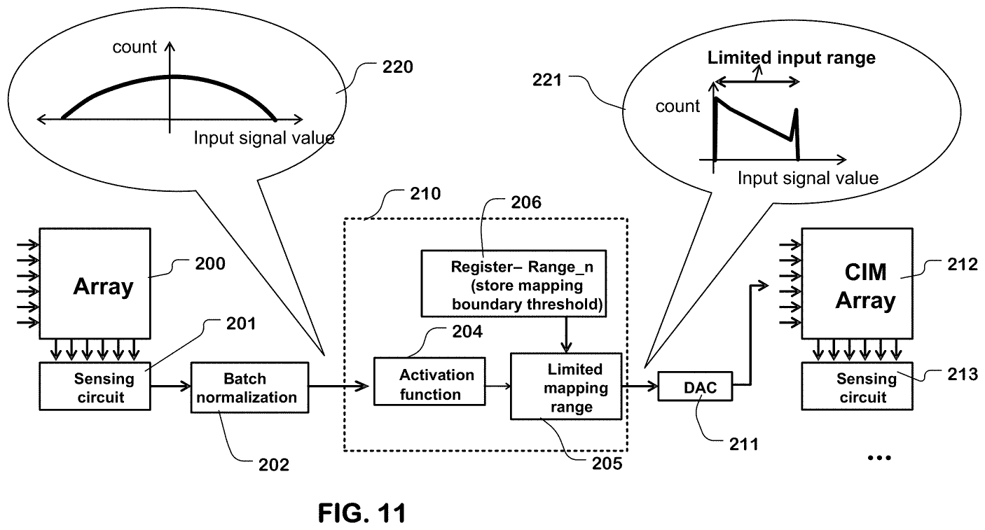

FIG. 11 illustrates an alternative implementation, in which the activation functions 204 can be combined with the clamping logic 205 in a single circuit. The combined activation function and clamping function may not have been used during training.

Thus, in this example, the memory array 200 of a previous layer in the neural network can output sum-of-products values to a sensing circuit 201. The outputs of the sensing circuit 201 can be applied to a batch normalization circuit 202 which generates a matrix having a distribution of output values as shown at 220. The output of the batch normalization circuit 202, or output directly from the sensing circuit 201 in some embodiments, can be applied to a combination activation function/clamping function logic 210 circuit. This logic 210 implements an activation function 204, and a clamping circuit 205 responsive to the range limit stored in the register 206. The output of the logic 210 comprises a clamped matrix having elements with a distribution of values as shown at 221, for the case in which the activation function implemented can be a ReLU function or a similar function. The elements of the clamped matrix are then applied to digital-to-analog converter DAC 211, which translate the values of the elements of the clamped matrix to the preferred range of voltages to be used for driving the array 212, store a kernel of coefficients (or weights) generated by a training procedure for use in the corresponding layer of the neural network. The array 212 generates sum-of-products outputs that are applied to a sensing circuit 213. The outputs of the sensing circuit can be processed for delivery to a next layer in the neural network, and so on.

The clamping function described herein is based on the operating characteristics of the CIM device. Applying this technology can include transferring one or more layers of a trained model to the CIM architecture, in which clamping function is applied. The clamp values are set according to the CIM memory device and to the layers in the network models. Therefore, this clamping function is flexible and tunable; it is not fixed by the training model.

An input mapping technique for neural networks deployed using analog NVM-based compute-in-memory circuits is described. By confining the input signal value range for the CIM array in the neural network to ranges that minimize the non-constant weight effect, the CIM system can achieve a good recognition accuracy. In embodiments of the technology, an extra function is included in the system to confine the input range. Stable threshold values for mapping are stored in the system, and can be programmable according to the characteristic of the distribution of values in the input matrix and the operating range and non-ideal conductance of the CIM array.

Embodiments are described for a compute-in-memory system. The technology can be applied in any system having the input signal flowing through analog computing units to attain multiplication, and the value (e.g. conductance) of the computing unit depends on the input signals.

While the present invention is disclosed by reference to the preferred embodiments and examples detailed above, it is to be understood that these examples are intended in an illustrative rather than in a limiting sense. It is contemplated that modifications and combinations will readily occur to those skilled in the art, which modifications and combinations will be within the spirit of the invention and the scope of the following claims.

What is claimed is:

1. An inference engine for a neural network, comprising:
a compute-in-memory array storing a kernel of coefficients, having inputs configured to receive a clamped input vector, and to produce an output vector representing a function of the clamped input vector and the kernel; and
a circuit operatively coupled to a source of an input vector, where elements of the input vector have values in a first range of values, the circuit configured to clamp the values of the elements of the input vector at a limit of a second range of values to provide the clamped input vector, the second range of values being more narrow than the first range of values.

2. The inference engine of claim 1, wherein the compute-in-memory array comprises memory cells storing elements of the kernel, the memory cells having conductances with deviations in amounts which are a function of input voltages at the memory cells and the conductances of the memory cells.

3. The inference engine of claim 1, wherein the compute-in-memory array comprises memory cells having conductances with deviations in amounts which are a function of input voltages at the memory cells.

4. The inference engine of claim 1, including a digital-to-analog converter to transduce the clamped input vector to analog voltages representing the elements of the clamped input vector, and to apply the analog voltages to the inputs of the compute-in-memory array.

5. The inference engine of claim 1, wherein the neural network comprises a plurality of layers, including a first layer, one or more intermediate layers and a final layer, and the compute-in-memory array is a component of an intermediate layer in the one or more intermediate layers, and the source of the input vector includes a preceding layer in the plurality of layers.

6. The inference engine of claim 5, wherein the preceding layer applies an activation function to generate the input vector.

7. The inference engine of claim 6, wherein the preceding layer generates the input vector, and the circuit configured to clamp the values of the elements of the input vector includes an activation function.

8. The inference engine of claim 1, wherein the neural network comprises a plurality of layers, including a first layer, one or more intermediate layers and a final layer, and the compute-in-memory array is a component of the first layer.

9. The inference engine of claim 1, wherein the neural network comprises a plurality of layers, including a first layer, one or more intermediate layers and a final layer, and the compute-in-memory array is a component of the final layer.

10. The inference engine of claim 1, wherein the input vector comprises elements in a floating point digital format.

11. The inference engine of claim 1, including a configuration register accessible by the circuit, the configuration register storing a parameter representing the limit of the second range.

12. The inference engine of claim 1, wherein the compute-in-memory array comprises programmable resistance memory cells.

13. The inference engine of claim 9, wherein the compute-in-memory array and the circuits are implemented on a single integrated circuit or multichip module.

14. A method for operating an inference engine for a neural network, comprising:
storing a kernel of coefficients in a compute-in-memory array;
applying a clamped input vector to the compute-in-memory array to produce an output vector representing a function of the clamped input vector and the kernel; and
modifying an input vector, where elements of the input vector have values in a first range of values, by clamping the values of the elements of the input vector at a limit of a second range of values to provide the clamped input vector, the second range of values being more narrow than the first range of values.

15. The method of claim 14, wherein the compute-in-memory array comprises memory cells storing elements of the kernel, the memory cells having conductances with deviations in amounts which are a function of input voltages at the memory cells and the conductances of the memory cells.

16. The method of claim 14, wherein the clamped input vector includes elements represented in digital form, and including converting the elements of clamped input vector to analog voltages and applying the analog voltages to inputs of the compute-in-memory array.

17. The method of claim 14, wherein the neural network comprises a plurality of layers, including a first layer, one or more intermediate layers and a final layer, and the compute-in-memory array is a component of an intermediate layer in the one or more intermediate layers and the source of the input vector is a preceding layer in the plurality of layers.

18. The method of claim 17, wherein the preceding layer applies an activation function to generate the input vector.

19. The method of claim 14, wherein the input vector comprises elements in a floating point digital format.

20. The method of claim 14, including storing a parameter representing the limit of the second range in a configuration register.
